(19) United States
(12) Patent Application Publication
(10) Pub. No.: US 2007/0272556 A1
(43) Pub. Date: Nov. 29, 2007

(54) Electrophoresis Capillaries Having Reduced Amounts of -Oh

(76) Inventor: Thomas E. Kane, State College, PA (US)

Correspondence Address: MCQUAIDE BLASKO, 811 UNIVERSITY DRIVE, STATE COLLEGE, PA, 16801, US

(21) Appl. No.: 10/558,100

(22) PCT Filed: May 21, 2004
(86) PCT No.: PCT/US04/15930

§ 371 Date: Jun. 7, 2007

Related U.S. Application Data
(60) Provisional application No. 60/472,402, filed on May 22, 2003.

(51) Int. Cl. G01N 27/00

(52) U.S. Cl. 204/601

(57) ABSTRACT

A silica substrate for subjecting a sample to electrophoresis has an —OH concentration of less than 100 parts per million.

### REFERENCE TO RELATED APPLICATIONS

The present application claims the benefit of U.S. Provisional Application No. 60/472,402, filed May 22, 2003, and International Application No. PCT/US2004/015930, filed May 21, 2004, which applications are entirely incorporated herein by reference.

### BACKGROUND OF THE INVENTION

The present invention relates to electrophoresis systems. More particularly, the invention relates to capillaries for use in electrophoresis separations.

Electrophoresis separations are commonly performed within the inner bore of a capillary.

One of the most common capillary materials is fused silica, such as may be found in capillaries available from Polymicro Technologies of AZ (See, Polymicro Technologies, The Book on the Technologies of Polymicro, 1998, Polymicro Technologies). Polyimide-clad fused silica capillaries possess structural, electrical and optical properties that are suited for capillary zone electrophoresis (CZE). Single capillary and multiple capillary systems that employ fused silica as the capillary material are commercially available.

In aqueous solution, pendant (SiOH) groups resident on the inner wall of silica capillaries are ionized to silonate groups (Si—O—) (See, Baker, Dale R.; Capillary Electrophoresis, 1995, John Wiley and Sons; and Grossman, Paul D., Colburn, Joel C., Capillary Electrophoresis Theory and Practice, 1992, Academic Press, Inc.). Negatively charged silonate groups attract positive ions in the buffer solution to ultimately form a positively charged mobile layer. This layer moves towards the anode under the influence of a potential drop across the length of the capillary. The mechanisms have been extensively described.

Typical fused silica electrophoresis capillaries contain approximately 400-600 ppm (parts per million) pendant hydroxide groups on the inner wall. In cases where the capillary has been prepared for the use in gas chromatography, pendant hydroxide concentrations as low as 200 ppm are available. The —OH concentration of silica is related to optical attenuation of the silica. See, e.g., G. Lu, G. F. Schotz, J. Vydra, D. Fabricant, “Optical Fiber for UV-IR Broadband Spectroscopy,” SPIE Proceedings, Optical Astronomical Instrumentation, V3355, pp 884-891, March 1998.

Known silica capillaries exhibit EOF unless the surface of the inner bore is chemically modified or coated in order to mask the (SiOH) groups. Electroosmotic flow (EOF) is often employed in CZE as a means to separate and detect all three charge states of solvated ions (positive, neutral and negative) at a single detection point along the length of the capillary. The separation mechanisms have also been described in great detail elsewhere. Excessive EOF, however, can hinder separation and can cause band broadening of detected peaks. EOF in CZE may be mathematically expressed as
μ_{OS}=σ*κ−1(ε, Ci)/η
Where
μ_{OS}=electroosmotic flow
σ*=surface charge density
κ−1=double-layer thickness
ε=electrical permittivity of the solvent
Ci=solute concentration
η=solution viscosity

Among the methods commonly employed to reduce or control EOF, three general methods are associated with the reduction of surface charge σ*:

(1) Titration of the surface species to an electro-neutral condition. The zero point for standard fused silica capillary is approximately pH 2.0. The requirement for acid conditions limits the types of buffer systems one may use, and can compromise the analyte species.

(2) Covalently coating the inner wall of the capillary. This has been done by several groups and represents the other major commercially available solution (See, Wiktorowicz, John E., U.S. Pat. No. 5,181,999; and Karger et al., U.S. Pat. No. 5,089,106). The performance of separations within coated capillaries, however, can change with time. This is due primarily to mechanical and chemical degradation of the coating as a result of replacing fluid matrix and using under aggressive chemical conditions. Hydrolysis is a common degradation process when using coated capillaries for separation of biopolymers.

(3) Masking the surface charge with adsorbates. This is a common process employed when using uncoated capillaries. For capillary gel electrophoresis, a matrix polymer often serves as the surface adsorbate, or dynamic coating (See, Grossman, Paul D., U.S. Pat. No. 5,126,021; Madabhushi et al., U.S. Pat. No. 5,567,292; Madabhushi et al., U.S. Pat. No. 5,552,028; Demorest et al., U.S. Pat. No. 5,264,101; and Lauer et al., U.S. Pat. No. 5,240,576) as well as a sieving material. Surface adsorbates generally require replacement at intervals of use. The uniformity of the surface adsorbate may vary especially between different capillaries of an array.

More recently, alternatives to fused silica have been reported (See, Engelhardt et al., U.S. Pat. No. 5,888,366). Plastic capillary tubing composed of polyetheretherketone (PEEK) and poly(tetrafluoroethylene) (PTFE) has been demonstrated as an alternative to fused silica, however these materials have not been demonstrated to be commercially viable at this time. Even with synthetic polymer capillaries, a surface charge is present when a buffer is employed in the capillary.

### SUMMARY OF THE INVENTION

The present invention relates to silica capillaries, such as synthetic fused silica capillaries.

In some embodiments, the capillaries comprise or consist essentially of silica having a bulk —OH concentration of less than 200 ppm, less than 150 ppm, less than 100 ppm, less than 50 ppm, less than 25 ppm, less than 5 ppm, less than 2.0 ppm, or less than 1.0 ppm.

The capillaries can have an internal bore. The diameter of the internal bore can be greater than 1 micron, greater than 5 microns, e.g., greater than 25 microns. The diameter of the internal bore can be less than 500 microns, less than 250 microns, less than 125 microns, e.g., less than 75 microns. The capillaries can have an outer diameter (not including any coating applied to an external surface of the capillary) of less than 1000 microns, less than 750 microns, less than 500 microns, or less than 250 microns.

The diameter of the inner bore can be substantially less than the length of the inner bore, for example, the diameter of the inner bore can be less than 1/500^{th}, less than 1/1000^{th} or less than 1/5000^{th} of the length of the inner bore.

The capillaries can be flexible, e.g., in some embodiments, the capillaries can be bent without breaking at a temperature of 25° C. or less into a 360° loop having a radius of less than 30 cm, less than 15 cm, e.g., less than 5 cm.

The capillaries can exhibit minimal electroosmotic flow even in the absence of any combination of (a) acidic conditions, e.g., at pH values of 4.0 or less, 3.0 or less, or 2.0 or less, (b) covalent coatings, and (c) adsorbates. Thus, for example, an inner surface of a capillary may be uncoated and/or operated at a pH greater than 2.0, greater than 3.0, or greater than 4.0 without exhibiting significant electroosmotic flow. Of course, it should be understood that capillaries in accordance with the invention may be operated with any combination of (a) acidic conditions, (b) covalent coatings, and (c) adsorbates.

In some embodiments, a capillary is formed of a fused silica having an optical attenuation of less than 50 dB/km, less than 25 dB/km, less than 15 dB/km, or even less than 5 dB/km at a wavelength of 950 nanometers. Alternatively, or in addition, capillaries of the invention may have the same optical transmission characteristics at 1250 nanometers. The optical transmission of silica of the capillaries may be determined using optical techniques.

In some embodiments, the capillaries comprise or consist essentially of silica having a transmission per meter of at least 98.5%, at least 99%, or at least 99.5% for at least one wavelength between 700 nm and 1300 nm, e.g., between 800 nm and 1250 nm. In some embodiments, the capillaries comprise or consist essentially of silica having a transmission per meter of at least 98.5%, at least 99%, or at least 99.5% between 700 nm and 1300 nm, e.g., between 800 nm and 1250 nm.

Fused silica forming a capillary in accordance with the invention may include one or more additives that increase the optical attenuation compared to the absence of such additives. Nonetheless, the attenuation due to —OH groups may be determined by measuring the attenuation of the fused silica including the additives and subtracting the component of the attenuation due to the additives. The attenuation component due to the additives may be determined from the concentration of the additives and the absorbance of those species. Thus, capillaries of the invention may be characterized with respect to optical attenuation due to the capillary material itself.

Employing materials of the invention in capillary electrophoresis can improve performance by reducing EOF due to a smaller native σ* contribution. Having considerably fewer pendant (SiOH) groups reduces the need for restrictive buffer pH conditions. A low (SiOH) concentration glass capillary maintains the mechanical and optical qualities of standard glass while improving the chemical properties.

Each of the references mentioned herein is incorporated by reference in its entirety.

### BRIEF DESCRIPTION OF THE DRAWINGS

FIG. 1 is a perspective view of an electrophoresis capillary according to an embodiment of the present invention.

FIG. 2 is an electrophoresis system including the capillary of FIG. 1 according to an embodiment of the present invention.

### DETAILED DESCRIPTION OF THE INVENTION

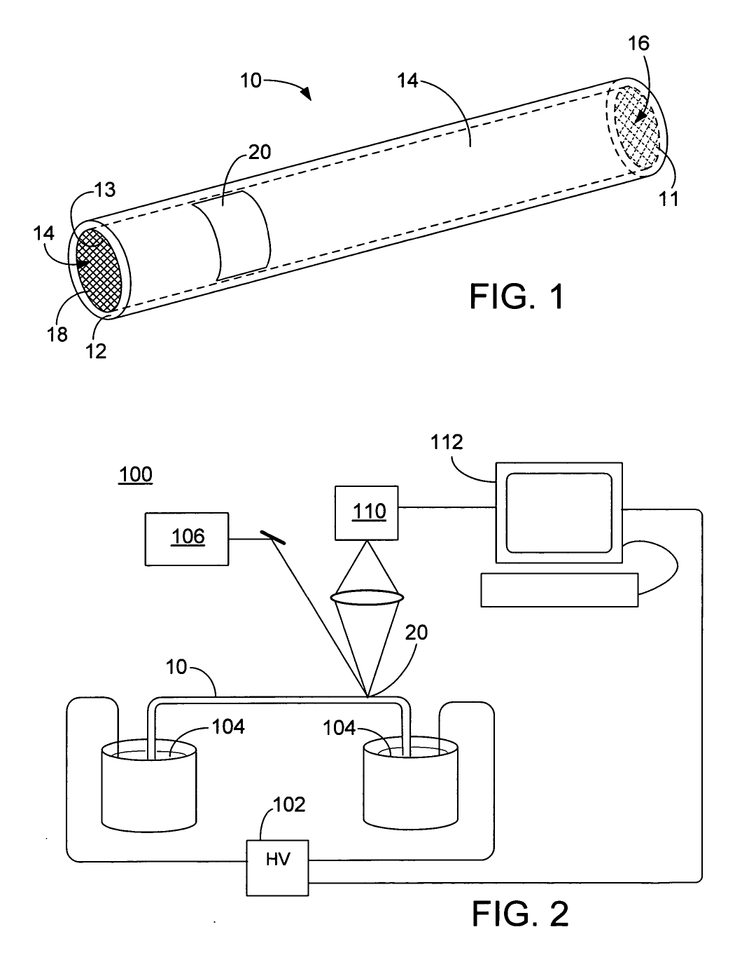

Referring now to FIG. 1, a capillary 10 includes a capillary wall 12 having an outer surface 14 and an inner surface 13. Outer surface 14 may include a coating, such as a protective coating, which may be opaque, e.g., a protective polyamide coating. Inner surface 13 defines an inner bore 11, which includes a first opening 16 and a second opening 18. Sample material to be subjected to separation, such as by electrophoresis, may be introduced to inner bore 11 via first opening 16. During separation, sample material migrates, such as under the influence of an electric field, along inner bore 11 toward second opening 18.

Capillary 10 may include a detection zone 20 intermediate the first and second openings 16, 18. Detection zone 20 is configured to allow at least one of (a) introduction of excitation light into capillary bore 11 through wall 12 and (b) escape of light from capillary bore 11 through wall 12. For example, excitation light may be laser light directed through capillary wall 12 into bore 11 and the escaping light may be fluorescence emitted by sample irradiated with the excitation light.

In some embodiments, the capillaries comprise or consist essentially of silica having a bulk —OH concentration of less than 200 ppm (parts per million), less than 150 ppm, less than 100 ppm, less than 50 ppm, less than 25 ppm, less than 5 ppm, less than 2.0, or less than 1.0 ppm.

In some embodiments, the capillaries have a concentration of less than 200 ppm (parts per million), less than 150 ppm, less than 100 ppm, such as less than 50 ppm pendent SiOH groups at an inner wall surface of the capillary. Exemplary capillaries comprise less than 25 ppm, for example less than 10 ppm, or even less than 0.5 ppm pendent SiOH groups. The capillaries may be operated without a coating or adsorbate so that a liquid of the separation medium, e.g., a buffer, directly contacts silica of the capillary. The capillaries may exhibit such SiOH group concentrations even at pH values of greater than 3.0, e.g., between about 4.0 and about 8.0.

In some embodiments, the inner bore of the capillary is essentially free of a dynamic coating or adsorbate. By essentially free it is meant that the capillary is free of an amount of the coating, adsorbate, or combination thereof that would be sufficient to reduce or prevent electroosmotic flow in capillaries having an —OH concentration of more than 200 ppm.

Inner bore 11 of capillary 10 may be filled with a separation medium. Preferred separation media include sieving media suitable for separating polynucleotide species. For example, suitable sieving media may comprise at least one of polyethylene oxide (PEO) and polyacrylamide. The separation medium may alternatively or additionally comprise a liquid, e.g., a buffer solution, such as one having a pH greater than 2.0, greater than 3.0, greater than 4.0 or even greater than 6.0.

A plurality of capillaries 10 may be combined to form an array of capillaries, such as a planar array. Suitable electrophoresis systems, which may be operated with one or more capillaries 10 are discussed in U.S. Pat. No. 6,352,633, issued Mar. 5, 2002, which patent is incorporated herein in its entirety.

Low —OH concentration material can be used to form microfabricated electrophoresis chips having first and second planar substrates defining a separation channel (bore) therebetween. The separation channel may include inner walls having reduced SiOH concentrations. The material forming the chip may have optical transmission characteristics identical with those discussed above.

An exemplary material for forming capillary 10 is product number F300TM silica available from InnovaQuartz, Inc., Phoenix, Ariz. This material may contain less than an —OH concentration of about 0.2 ppm or less.

Referring now to FIG. 2, an electrophoresis system 100 includes capillary 10 and a voltage source 102, which is in electrical communication with the inner bore of capillary 10 via buffer reservoirs 104. A light source 106 irradiates detection zone 20. Typically, detection is accomplished by fluorescence and light emitted by sample components is received and detected by a detector 110. System 100 is under the control of a processor 112, in communication with voltage source 102, light source 106, and detector 110.

Although system 100 shows a single capillary 100, arrays of capillaries, e.g. 64 capillary arrays or 96 capillary arrays may be used.

While the invention has been particularly shown and described with reference to the examples and preferred embodiments thereof, it will be understood by those skilled in the art that various alterations in form and detail may be made therein without departing from the spirit and scope of the invention.

What is claimed is:

1. An electrophoresis system, comprising:
a silica substrate defining an inner bore having an inner wall and first and second openings, wherein the silica of the silica substrate has an —OH concentration of less than 100 parts per million.

2. The system of claim 1, wherein the inner bore is at least partially filled with a liquid suitable for supporting an electrophoretic separation.

3. The system of claim 2, wherein the liquid comprises a buffer having a pH of at least 4.

4. The system of claim 2, wherein the inner wall is free of coatings or adsorbates other than a sieving medium, which is optionally present.

5. The system of claim 1, wherein the substrate is a capillary.

6. The system of claim 1, wherein the inner bore has a diameter of at least about 5 microns and less than about 250 microns.

7. A silica capillary comprised of silica having an —OH concentration of less than 100 parts per million and defining an inner bore at least partially filled with a buffer solution.

8. An electrophoresis system comprising the capillary of claim 7.

9. A silica electrophoresis capillary, comprising an inner bore comprising an uncoated inner wall and having an SiOH concentration at a surface of the inner wall of less than 100 parts per million at a pH of greater than 2.

10. An electrophoresis system, comprising a silica capillary defining an inner bore having an inner wall and first and second openings, wherein the silica of the silica capillary has an —OH concentration of less than 100 parts per million.

11. A silica capillary comprised of silica having a transmission per meter of at least 99% for at least one wavelength between 700 nm and 1300 nm and defining an inner bore at least partially filled with a buffer solution.
